(19) United States
(12) Patent Application Publication
(10) Pub. No.: US 2004/0090429 A1
(43) Pub. Date: May 13, 2004

(54) Touch sensor and method of making

(76) Inventors: Bernard O. Geaghan, Salem, NH (US); Elisa M. Cross, Woodbury, MN (US); Robert S. Moshrefzadeh, Oakdale, MN (US)

Correspondence Address: 3M INNOVATIVE PROPERTIES COMPANY, PO BOX 33427, ST. PAUL, MN, 55133-3427, US

(21) Appl. No.: 10/292,165

(22) Filed: Nov. 12, 2002

(51) Int. Cl. G09G 5/00

(52) U.S. Cl. 345/173

(57) ABSTRACT

The present invention provides a touch sensor that includes a first layer movable toward a second layer in response to a touch input, the location of the touch input being determinable from signals detected due to the movement of the first layer. The first and second layers are bonded together through a plurality of spacers distributed over the touch sensitive area of the sensor. The present invention also provides methods for bonding spacers to the first and second layers to make a touch sensor.

### BACKGROUND

Resistive touch sensors have found wide application as input devices for computers, personal digital assistants and a variety of display devices that can make use of touch or writing input. A typical resistive touch screen mounts in front of a display device such as a cathode ray tube (CRT) or liquid crystal display (LCD), and couples to an electronic controller. The touch screen includes a flexible topsheet and a rigid substrate with transparent resistive coatings on their facing surfaces. A separation is maintained between the resistive coatings of the topsheet and substrate by a peripheral spacer. A matrix of spacer dots is provided on the resistive coating of the substrate to help prevent spurious contact between the resistive coatings that would result in an unintended touch input. The diameter, height, and spacing of the spacer dots determines the activation force of the sensor, the activation force being the amount of force from a touch implement required to bring the resistive coatings into contact so that a touch input can be registered.

### SUMMARY OF THE INVENTION

The present invention provides a touch sensor that includes a first layer that is movable toward a second layer in response to a touch in the touch-sensitive area of the sensor. As a result of the first layer being moved toward the second layer, a signal is produced that can be detected to determine the location of the touch. A plurality of spacers are disposed in the touch-sensitive area between the first and second layers, and the spacers are bonded to both the first layer and the second layer.

The present invention also provides a method of making a touch sensor. The method includes configuring a first layer and a second layer with a gap between them, disposing a plurality of spacers in a touch-sensitive area between the first and second layers, and bonding the spacers to both the first layer and the second layer.

### BRIEF DESCRIPTION OF THE DRAWINGS

The invention may be more completely understood in consideration of the following detailed description of various embodiments of the invention in connection with the accompanying drawings, in which:

FIG. 1 is a schematic side view of a touch sensor including double-bonded spacers;

FIG. 2 is a three-dimensional schematic exploded view of a 4-wire resistive touch sensor;

FIG. 3 is a partial schematic side view of a resistive touch sensor;

FIG. 4 is a partial schematic side view of a resistive touch sensor having double-bonded spacers in accordance with the present invention;

FIG. 5 is a three-dimensional schematic exploded view of a 4-wire resistive touch sensor having single-bonded and double-bonded spacers;

FIGS. 6A-C depict steps in a method of forming a resistive touch sensor using a double bonding technique of the present invention;

FIGS. 7A-C depict steps in a method of forming a touch sensor using a double bonding technique of the present invention; and

FIG. 8 is a schematic representation of a display system that includes a touch sensor.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

In conventional resistive touch sensor constructions, a flexible topsheet, which provides the touch surface, is generally attached to a rigid substrate along its edges via a peripheral sealing spacer, and the topsheet is drawn taut in an attempt to maintain a uniform gap. The need to keep the topsheet flat and tight requires that a significant amount of the border area be dedicated to the peripheral spacer for this attachment function. Since the topsheet can slide freely over the tops of the spacer dots, it can sag down, bubble up, or stretch with use or as environmental conditions change. This type of wear to the topsheet can be visually displeasing, interfere with normal operation, cause shorting of the resistive coatings, and produce unwanted, annoying optical artifacts such as Newton's rings. Repeated topsheet contact against the spacer dots can also damage or dislodge the spacer dots.

A more robust yet flexible resistive touch sensor with a more uniform and enduring gap less subject to buckling, bubbling, and sagging and without the attendant erroneous signals and annoying artifacts can be achieved by attaching the spacer dots in the gap to both the substrate and the topsheet. Such double bonding of the spacer dots can greatly reduce slipping of the topsheet so that any sagging, bubbling or buckling occurs only locally, for example in areas between double-bonded spacer dots. As such, the topsheet can be better controlled to avoid erroneous signals and annoying visual effects.

While the present invention is well-suited for use in resistive touch screen constructions, the present invention applies to any touch sensor having a construction that includes a first layer (such as a flexible topsheet) that is movable toward a second layer (such as a rigid substrate) in response to a sufficient touch input on the touch surface. Local deformation of the first layer in response to the touch brings the first and second layers into close enough proximity that a signal can be detected from which the touch location can be determined. Touch sensors that detect a signal upon physical contact of two resistive layers are called resistive touch sensors. Other touch sensors can detect signals resulting from the local change in separation between the first and second layers, for example a change in capacitance between two resistive layers when one is brought locally into closer proximity. Examples of such touch sensors are disclosed in co-owned U.S. patent application Ser. No. 10/183,876, as well as in U.S. Pat. Nos. 5,686,705 and 6,002,389, the disclosures of which documents are wholly incorporated into this document.

While resistive touch sensors often employ spacer dots, structures other than dots, which are typically realized as hemispherical shapes, can be used as spacers in the spacer array disposed across the touch-sensitive area of a touch sensor according to the present invention. For example, the spacer array can include dots, spheres, elongated shapes, lines, and any other suitable shape. A spacer array can include spacers of all one shape, size, or distribution, or can includes spacers having different shapes, sizes, or distributions. Without loss of generality, spacers in the spacer array may be referred to as spacer dots or simply as spacers in this document.

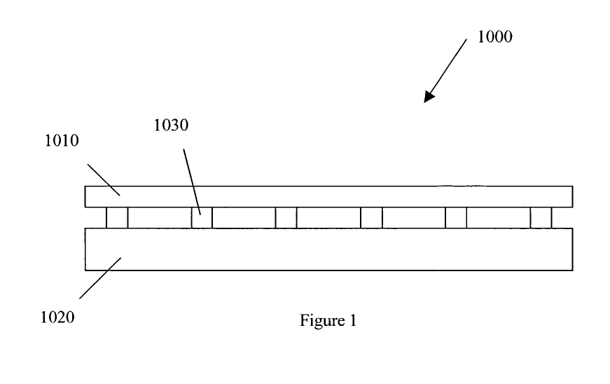

FIG. 1 schematically shows a touch sensor 1000 that includes a movable first layer 1010 spaced apart from a second layer 1020. Spacers 1030 are disposed between and bonded to each of the first layer 1010 and the second layer 1020. Spacers 1030 are disposed in a touch-sensitive area of the sensor 1000. A touch input to a touch surface in the touch-sensitive area causes first layer 1010 to be moved toward second layer 1020. Spacers, including double-bonded spacers 1030 and optional single-bonded spacers (not shown), encourage the deformation of first layer 1010 under the touch to occur locally. The size, shape, and distribution of the various spacers determines the amount of force and area of force required to cause a movement sufficient to result in a detectable signal. The deformation of first layer 1010 due to the touch brings the first layer 1010 and the second layer 1020 either into contact or into closer proximity. First layer 1010 and second layer 1020 are typically provided with resistive elements such as a resistive layer covering the touch-sensitive area. The resistive elements can be biased so that a touch input results in a detectable signal that can be used to determine the location of the touch. By touch or touch input, it is meant that a touch implement such as a finger, stylus, or other suitable object is used to apply pressure to the touch surface in the touch-sensitive area of the touch sensor.

The materials of the first layer 1010 and second layer 1020 can be selected so that a display (not shown) can be viewed through the touch sensor 1000. The gap between the first layer 1010 and second layer 1020 can optionally be filled with a deformable material such as a liquid or an elastomer. The filler material can also be selected so that a display can be viewed through the sensor 1000. The presence of a gap filler can produce improved optics by eliminating the air gap between the layers, thereby reducing reflections that can limit light throughput. The present invention may be particularly suited to applications where a flowable gap filler material is used. When a flowable gap filler is used, the gap filler in the touched area is pushed into the surrounding areas, which can cause the movable first layer to be pushed away from the second layer in an annulus around the touched area. This may form air pockets, leading to bubble formation that detracts from viewability through the sensor. The presence of double-bonded spacers may help prevent this by containing excessive motion of the movable first layer away from the second layer.

In conventional resistive touch sensors, the spacer dots are typically made of a rigid material such as an acrylic. In the present invention, the spacers disposed in the touch-sensitive area of the touch sensor can be rigid or deformable. For example, it may be desirable to include double-bonded spacers that are sufficiently deformable to be somewhat yielding under touch forces but that return to their rest state upon removal of the touch force. Elastomers such as silicone elastomers can be used as deformable spacer materials.

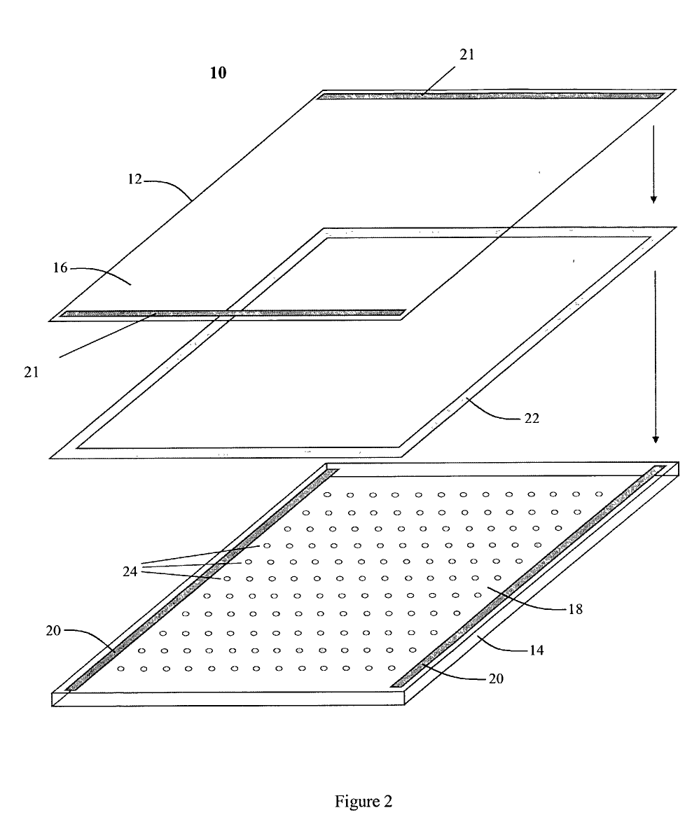

To exemplify some aspects of the present invention, and without loss of generality, there is shown in FIG. 2 a 4-wire resistive touch sensor 10 including a top sheet 12, which may be made of, for example, polyethylene terephthalate (PET), and a substrate 14, which may be made of, for example, glass. A resistive coating 16 is applied to topsheet 12 and another resistive coating 18 is applied to substrate 14 in facing relationship to one another. The resistive coatings may be made of any suitable resistive material, particularly transparent conductive oxides such as indium tin oxide (ITO), tin oxide (TO), or antimony tin oxide (ATO) for applications where it is desirable for touch sensor 10 to be transparent. Topsheet 12 and substrate 14 may have thicknesses of about 0.03 to 0.5 mm and 0.5 to 5 mm respectively, for example.

Touch sensor 10 is shown to be generally rectangular and the materials are indicated to be transparent so the sensor can be used as a touch screen overlay on a display device such as an LCD or CRT screen. The present invention also applies to whiteboards, touchpads, and other touch sensor devices that are not transparent. Also, although FIG. 2 shows a 4-wire resistive touch sensor, the present invention applies equally well to any resistive touch sensor that includes a topsheet with a resistive layer spaced apart from a substrate with a resistive layer and spacer dots disposed between the resistive layers. Other resistive touch sensor types include 5-wire and 8-wire, the constructions of which are well known to those of ordinary skill in the art.

Referring back to FIG. 2, electrodes 20 may be printed or otherwise disposed on substrate 14 for applying voltages and sensing signals. Electrodes 21 may be printed or otherwise disposed on topsheet 12 for applying voltages and sensing signals. The sensed signals result from a touch input of sufficient force to bring the resistive coatings 16 and 18 into electrical contact. Information gathered from sensing these signals can be used to determine the location of the touch.

An adhesive medium 22 is conventionally applied along the periphery between topsheet 12 and substrate 14 to form a seal. The seal protects the inside of the sensor from contaminants, and also provides a support on which the topsheet can be pulled taut and to which the topsheet may be bonded to help reduce topsheet sag, buckle, and bubble effects. In the present invention, an adhesive border or periphery may still be desirable to seal the gap between the top sheet and substrate 14 to prevent contamination.

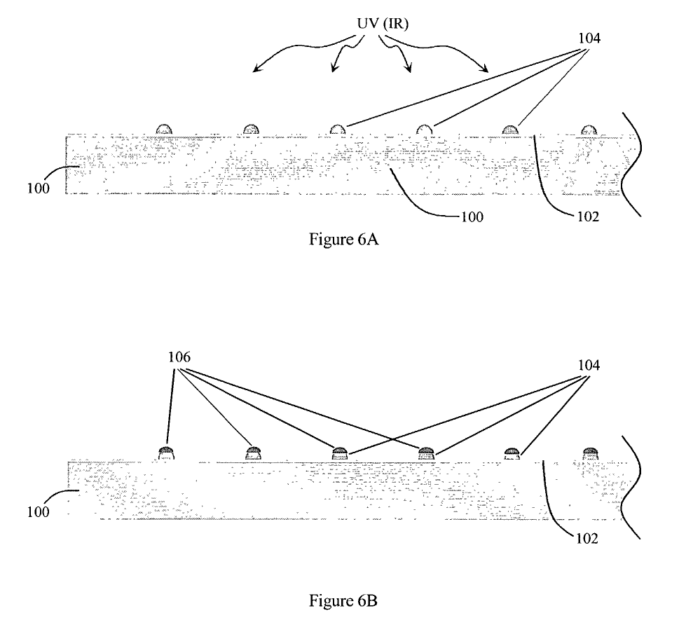

The gap between the resistive coatings 16 and 18 is maintained by spacers 24 disposed over the touch-sensitive area of the sensor. Spacers 24 may be arranged in any regular or random array, although they are shown in FIG. 2 to be arranged in an array of rows and columns. Spacers may be rounded, squared or elongated, and may form lines across the touch-sensitive area. The spacers may be formed from any suitable material such as an acrylic material, and can be formed conventionally by screen printing, offset printing, stenciling, photolithography, and the like. Spacers can also be formed by ink jet printing as disclosed in co-owned U.S. patent application Ser. No. 10/017,268, the disclosure of which is wholly incorporated into this document. Spacers can also be formed by embossing or micromolding techniques whereby the spacers are embossed or molded directly onto a resistive layer of the touch sensor. Alternatively, spacer structures may be formed separately as particles or fibers, for example, that can be distributed over a resistive layer of the sensor. In such a case, an adhesive material may be pre-printed or otherwise disposed in selected areas on a resistive layer of the touch sensor so that the distributed spacers can adhere to those selected areas, thereby fixing their positions. Alternatively, spacer particles may be adhesive, for example particles having an adhesive coating. Exemplary spacers may be approximately 1 to 100 microns in diameter or width, 0.5 to 50 microns in height, and spaced apart approximately 1 cm or less, for example. While all the spacers are typically spaced apart an average of 1 cm or less from neighboring spacers, it should be noted that the distance between neighboring double-bonded spacers may be much larger, for example as shown in FIG. 5.

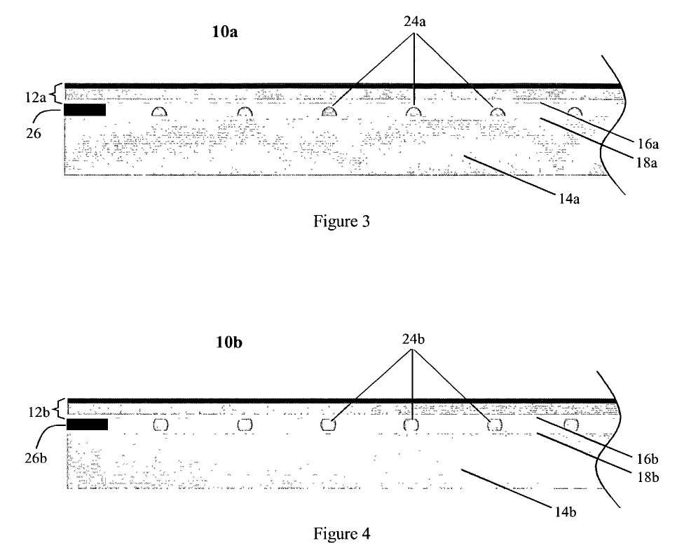

For comparison, FIG. 3 shows a conventional resistive touch sensor 10a that includes a topsheet 12a having a resistive layer 16a, a substrate 14a having a resistive layer 18a, a peripheral spacer 26 setting the gap and sealing between the topsheet and the substrate, and a plurality of spacer dots 24a adhered to the resistive coating 18a of the substrate. Topsheet 12a floats above spacer dots 24a, and there may be a small gap between the top of each spacer dot 24a and the neighboring resistive coating 16a. This allows the top sheet to slip with respect to the substrate 14a. While topsheet 12a may at times make contact with some spacer dots 24a, even in the absence of a touch input, the spacer dots 24a are not bonded to the topsheet resistive layer 16a. Any differential forces placed on the topsheet may be propagated across the entire length and breadth of the topsheet, allowing large scale buckling, bubbling, or sagging across many rows and columns of spacer dots.

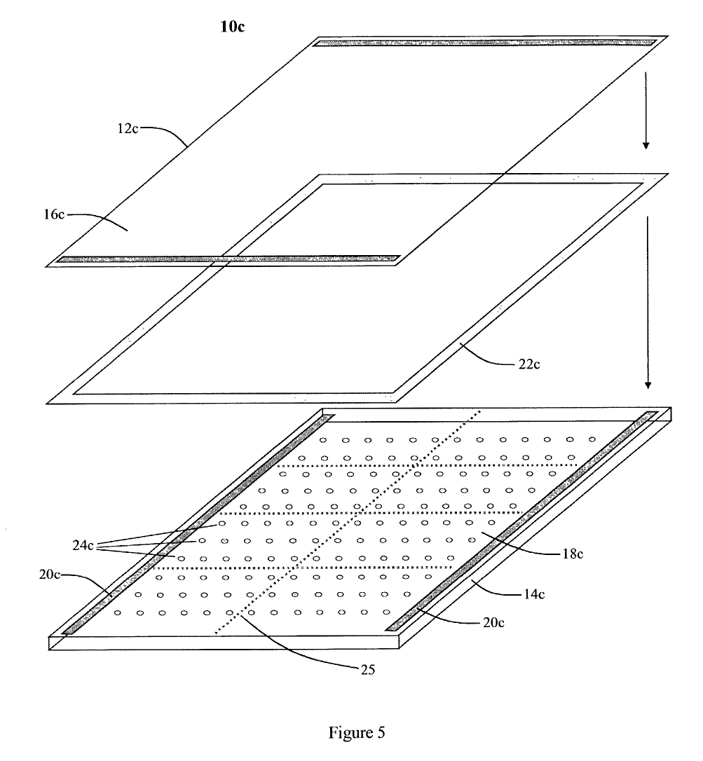

FIG. 4 shows a resistive touch sensor 10b in accordance with the present invention where the spacers 24b are bonded to both the resistive coating 18b on substrate 14b and the resistive coating 16b on topsheet 12b. In this way, it is possible to obtain a more rugged and robust touch sensor where the expansion, contraction or other movement or reconfiguration of topsheet 12b is contained within local areas between double bonded spacer dots 24b. A peripheral seal 26b may still be included.

In some embodiments, it may be desirable to bond all spacers to both resistive layers of the touch sensor. In other embodiments, it may be desirable to bond only a portion of the spacers to both the topsheet and substrate, while the other spacers are bonded to only one of the topsheet and substrate. For example, double bonding all spacers may result in an undesirably high activation force for the sensor, especially when the spacing between spacers is relatively small or the height of the spacers is relatively large. In these instances, it may be desirable to bond only a portion of the spacers to both the topsheet and the substrate, for example every fourth spacer in a row or column of spacers. FIG. 5 depicts another exemplary case where resistive touch sensor 10c includes a plurality of dot spacers 24c and a plurality of line spacers 25, the dot spacers 24c being bonded only to resistive layer 18c of substrate 14c, and the line spacers 25 being bonded to both resistive layer 18c of substrate 14c and resistive layer 16c of topsheet 12c. The present invention contemplates any suitable construction where the size, shape, placement, and bonding characteristics (e.g., single versus double) of the spacers are varied or mixed.

Optional coatings and layers can also be provided such as hard coat layers, antireflective layers, light diffusing layers, anti-microbial layers, and so forth, as will be appreciated by those of skill in the art. For example, a hard coat provided on the top surface of the topsheet can help protect the sensor from scratches. A hard coat is typically a cured acrylic resin, coated onto the surface of a substrate by applying a liquid acrylic material, then evaporating away the solvents in the liquid, then curing the acrylic with UV radiation. The acrylic may also contain silica particles that give a roughened finish to the cured hard coat, yielding anti-glare or diffusing optical properties.

Spacers included in transparent touch screens preferably have characteristics that cause the spacers not to undesirably interfere with light to be transmitted through the sensor, for example from a display. For example, the spacers can be made having a dimension small enough so as not to be noticed by a user. The spacers can be shaped to inhibit the focusing of light passing through the touch screen although practically this may be difficult. According to the present invention, adverse effects due to light focusing through the spacers may be alleviated by bonding the spacers to both the top and bottom layers. Focusing of light by spacer dots can make them more visible to the user. In addition, by bonding the spacers to both the substrate and to the topsheet according to the present invention, an air interface is eliminated that may allow transmission of visible light through the spacers, making the spacers appear as bright spots, segments, or lines to the user. To minimize this in situations where the effect is undesirable, the spacers can be made as small as possible, light diffusing particles may be added to the spacers to scatter light, the spacers can be tinted with a color or made of a material that does not transmit light, for example to minimize visibility, and so forth.

Resistive touch sensors can be made according to the present invention by bonding a plurality of spacers disposed in the touch-sensitive area of the touch sensor to both the topsheet resistive layer and the substrate resistive layer. For example, a plurality of spacers can first be disposed on and adhered to either the topsheet resistive layer or the substrate resistive layer. This can be done by any suitable patterning method such as screen printing, photolithography, micro-molding, ink jet printing, or the like. If the disposed spacers comprise a bonding material, it may be possible to then adhere the other of the topsheet or substrate directly to the spacers. For example, the spacers may include a partially cured material that can be contacted with the other of the topsheet or substrate and then more fully cured to bond the spacers to the other layer. As another example, the spacers may include a thermoplastic material that can be heated during contact with both the substrate and the topsheet so that upon cooling the spacers are adhered to both layers. In other cases, an adhesive or other bonding material can be disposed on each spacer after the spacers have been disposed so that the other layer can be bonded to the spacers via the added adhesive or bonding material.

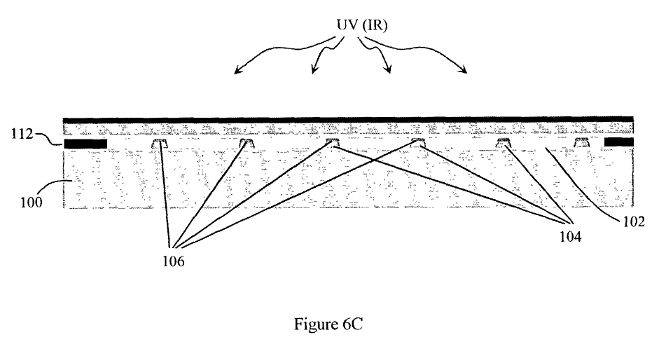

FIGS. 6A-C show steps that may be performed according to the present invention. FIG. 6A shows a substrate 100 on which is disposed a resistive coating 102. Alternatively, the topsheet could be used. On the resistive coating 102 is provided an array of spacer dots 104. These spacers may be screen printed or otherwise formed as indicated previously. As shown, the spacers are formed from a UV curable material, for example a curable acrylic such as the products ML 25265 or PD-038 made by Acheson Colloids of Port Huron, Mich., so that exposure to UV radiation can be used to cure the spacers, adhering them to the resistive layer 102.

A layer of bonding medium 106 may be applied on top of each spacer 104 as shown in FIG. 6B. The bonding medium 106 may be applied by first wetting the surface of a flat plate with the bonding medium and touching the plate to the spacers 104, thus depositing a bit of bonding medium onto the top of each spacer 104 without depositing bonding medium onto the resistive coating 102. The bonding medium 106 may also be applied by ink jetting an amount of bonding material onto each of the spacers. The bonding medium 106 may also be applied by depositing bonding material through apertures of a stencil used with a stenciling machine, especially if the same stencil was used to form the spacers. Other suitable methods of supplying the additional bonding medium on the spacers can also be used.

As shown in FIG. 6C, and an adhesive sealing material 112 may be applied around the periphery of the touch sensor and topsheet 108 may then be applied on top of spacers 104 and bonding medium 106 with the resistive coating 110 of the topsheet 108 in contact with the bonding medium 106. As shown, the bonding medium is UV curable so that exposure to UV radiation cures the bonding medium 106 to bond the spacers 104 to topsheet resistive coating 110. Such a process can be used to double bond the spacers 104 to resistive coating 110 on topsheet 108 as well as to resistive coating 102 on substrate 100.

The steps as depicted in FIG. 6 can be varied. For example, curing of either or both the spacers and the optional additional bonding medium can be performed through other means such as heat, chemicals, hardeners, infrared radiation, visible light, electron beam radiation, or similar means. Also, as discussed, the spacers themselves can be formed of a bonding medium so that after being formed on one of the topsheet and the substrate, the other of the topsheet and substrate can be directly bonded thereto, possibly upon appropriate application of radiation, heat, pressure, or the like. For example, the spacers may be an adhesive material ink jetted onto a resistive layer of the substrate or topsheet that is partially cured for initial bonding and then more fully cured after contact with the other resistive layer.

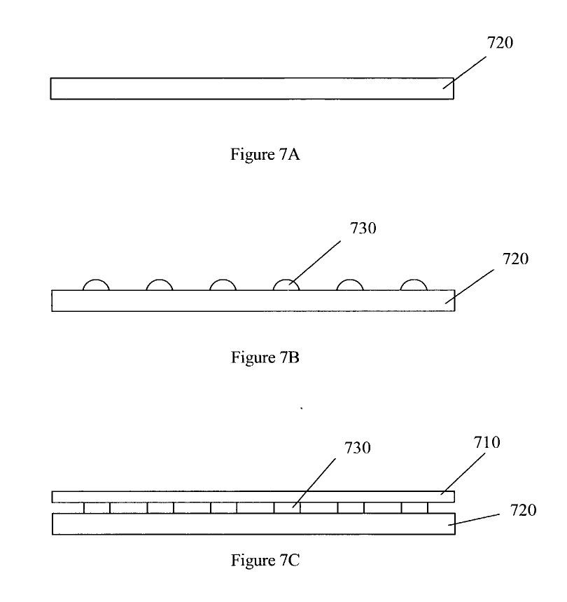

FIGS. 7A-C show steps that may be performed according to the present invention to make a touch sensor that incorporates double-bonded spacers. FIG. 7A shows a layer 720 that can either be the first, movable layer of the touch sensor, or the second layer. Spacers 730 can then be printed or transferred onto layer 720, resulting in FIG. 7B. Spacers 730 include an adhesive material. For example, spacers 730 may be a pressure sensitive adhesive material that is ink jet printed, transferred from a micromold, or otherwise printed or transferred onto layer 720. A pressure sensitive adhesive can be transferred from a micromold by providing a micromold such as a roll, plate, or film having an array of indentations having sizes on the order of the spacers, coating a pressure sensitive adhesive material into the indentations of the micromold, and pressing the micromold onto layer 720 to thereby transfer the pressure sensitive adhesive material. Preferably, the spacer material adheres sufficiently better to layer 720 than to the micromold to promote transfer of the spacer material. After forming the adhesive spacers 730 on layer 720, the adhesive spacers can optionally be partially cured to better adhere them to layer 720. Partial curing preferably leaves the spacers with enough remaining adhesiveness to bond them to layer 710 as shown in FIG. 7C. Layer 710 is brought into contact with the adhesive spacers 730, and bonding can occur by pressure, heat, radiation, and so forth.

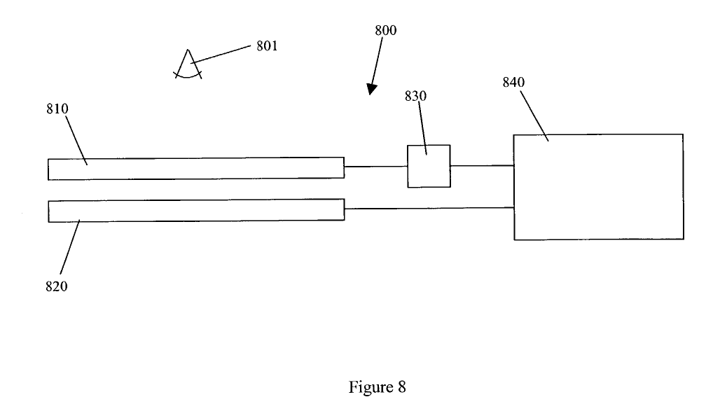

Touch sensors of the present invention can be used in any suitable system or application. In exemplary situations, touch sensors of the present invention may be used in display systems such as the display system 800 shown in FIG. 8. Display system 800 includes a touch sensor 810 disposed proximate an electronic display 820. Both the touch sensor 810 and display 820 are coupled to a central processor 840 such as a personal computer. Touch sensor 810 is coupled to processor 840 through controller 830. Controller 830 helps communicate information from the touch sensor to the processor and vice versa so that user inputs can be properly registered, acted upon, and displayed. Controller 830 is shown schematically as a separate item but may be integrally formed on or supplied directly with the touch sensor 810, or may be incorporated into the electronics of processor 840. In display system 800, display 820 is positioned to be viewed by user 801 through the touch sensor 810.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A touch sensor having a touch-sensitive area comprising:
a first layer and a second layer separated by a gap, the first layer movable toward the second layer in response to a touch in the touch-sensitive area to generate a signal for determining the touch location; and
a plurality of double-bonded spacers disposed within the touch-sensitive area and bonded to both the first and second layers.

2. The touch sensor of claim 1, further comprising a plurality of single-bonded spacers, each bonded only to the first layer or the second layer.

3. The touch sensor of claim 1, wherein further comprising a deformable material substantially filling the gap between the first and second layers.

4. The touch sensor of claim 3, wherein the deformable material comprises a liquid.

5. The touch sensor of claim 1, wherein the first layer is a topsheet comprising a first resistive layer and the second layer is a substrate comprising a second resistive layer.

6. The touch sensor of claim 5, wherein the signal is generated when the first resistive layer contacts the second resistive layer.

7. The touch sensor of claim 5, wherein the signal is generated when the first resistive layer is brought into local proximity with the second resistive layer sufficient for detectable capacitive coupling.

8. The touch sensor of claim 5, wherein the substrate, the topsheet and the first and second resistive coatings are transparent.

9. The touch sensor of claim 5, wherein the substrate comprises glass.

10. The touch sensor of claim 5, wherein the topsheet comprises PET.

11. The touch sensor of claim 5, wherein at least one of the first and second resistive coatings comprises a metal oxide.

12. The touch sensor of claim 5, wherein at least one of the first and second resistive coatings comprises a conductive polymer.

13. The touch sensor of claim 5, wherein the topsheet includes a hard coat on its outer surface.

14. The touch sensor of claim 5, wherein the topsheet includes an antireflective coating.

15. The touch sensor of claim 5, wherein the topsheet includes a diffusive coating.

16. The touch sensor of claim 1, wherein the double-bonded spacers comprise an acrylic material.

17. The touch sensor of claim 1, wherein the double-bonded bonded spacers comprise an adhesive material.

18. The touch sensor of claim 1, wherein the double-bonded bonded spacers comprise a pressure sensitive adhesive.

19. The touch sensor of claim 1, wherein the double-bonded spacers comprise a light diffusing material.

20. The touch sensor of claim 1, wherein the double-bonded spacers comprise a light absorbing material.

21. The touch sensor of claim 1, wherein the double-bonded spacers comprise a deformable material.

22. The touch sensor of claim 1, wherein the double-bonded spacers are arranged in rows and columns.

23. The touch sensor of claim 1, wherein the double-bonded spacers are spaced apart approximately 1 cm or less.

24. The touch sensor of claim 1, wherein the double-bonded spacers are approximately 1 to 100 microns in diameter or width.

25. The touch sensor of claim 1, wherein the double-bonded spacers are approximately 0.5 to 50 microns in height.

26. The touch sensor of claim 1, wherein the double-bonded spacers comprise hemispherical dots.

27. The touch sensor of claim 1, wherein the double-bonded spacers comprise elongated shapes.

28. The touch sensor of claim 1, wherein the double-bonded spacers comprise lines.

29. The touch sensor of claim 1, wherein the touch sensor is flexible.

30. The touch sensor of claim 1, wherein the first and second layers are sealed together around their peripheries.

31. The touch sensor of claim 1, further comprising electrodes configured to apply and sense signals for determining the touch location.

32. The touch sensor of claim 1, wherein the first and second layers are generally rectangular.

33. A method of making a touch sensor comprising:
configuring a first layer and a second layer separated by a gap;
disposing a plurality of spacers in a touch-sensitive area between the first and second layers; and
bonding the plurality of spacers to both the first layer and the second layer, wherein the first layer is capable of being moved toward the second layer in response to a touch in the touch-sensitive area to generate a signal for determining the touch location.

34. The method of claim 33, wherein the disposing and bonding steps comprise:
forming the plurality of spacers adhered to one of the first and second layers;
applying a bonding medium to at least a portion of the formed spacers; and
contacting the applied bonding medium on the spacers with the other of the first and second layers.

35. The method of claim 34, wherein the step of forming the spacers comprises screen printing.

36. The method of claim 34, wherein the step of forming the spacers comprises offset printing.

37. The method of claim 34, wherein the step of forming the spacers comprises ink jet printing.

38. The method of claim 34, wherein the step of forming the spacers comprises stenciling.

39. The method of claim 34, wherein the step of forming the spacers comprises embossing.

40. The method of claim 34, wherein the step of forming the spacers comprises micromolding.

41. The method of claim 34, wherein the bonding medium comprises a radiation curable adhesive.

42. The method of claim 34, wherein the step of applying the bonding medium comprises coating the bonding medium onto a pad and touching the bonding medium on the pad to spacers.

43. The method of claim 34, wherein the step of applying the bonding medium comprises screen printing.

44. The method of claim 34, wherein the step of applying the bonding medium comprises stenciling.

45. The method of claim 34, wherein the step of applying the bonding medium comprises ink jet printing.

46. The method of claim 34, wherein the step of applying the bonding medium comprises offset printing.

47. The method of claim 33, wherein the disposing and bonding steps comprise:
printing an adhesive material to form the plurality of spacers on one of the first and second layers; and
contacting the printed adhesive spacers with the other of the first and second layers.

48. The method of claim 47, wherein the step of printing an adhesive material comprises ink jet printing.

49. The method of claim 47, wherein the step of printing an adhesive material comprises screen printing.

50. The method of claim 47, wherein the step of printing an adhesive material comprises transferring the adhesive material from a micromold.

51. The method of claim 47, wherein the adhesive material comprises a pressure sensitive adhesive.

52. The method of claim 47, further comprising partially curing the adhesive material after the printing step and before the contacting step.

53. The method of claim 47, further comprising curing the adhesive material after the contacting step.

54. A display system comprising:
an electronic display coupled to a central processor; and
a touch sensor couple to the central processor through a controller unit, the touch sensor configured to communicate information from touch inputs to the central processor, the touch sensor comprising
a first layer and a second layer separated by a gap, the first layer movable toward the second layer in response to a touch in the touch-sensitive area to generate a signal for determining the touch location; and
a plurality of double-bonded spacers disposed within the touch-sensitive area and bonded to both the first and second layers.
